(19) United States
(12) Patent Application Publication
(10) Pub. No.: US 2009/0150359 A1
(43) Pub. Date: Jun. 11, 2009

(54) DOCUMENT PROCESSING APPARATUS AND SEARCH METHOD

(75) Inventor: Yuka Masuyama, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/331,141

(22) Filed: Dec. 9, 2008

(30) Foreign Application Priority Data
Dec. 10, 2007 (JP) 2007-318994

(51) Int. Cl. G06F 7/06; G06F 17/30

(52) U.S. Cl. 707/3; 707/E17.014

(57) ABSTRACT

Overlapping of objects included in document data is detected, and information indicating overlapping of objects is added to metadata. A user sets search conditions including a condition relating to the overlapping of objects, an object that satisfies the search conditions set is searched for based on the metadata, and a search result is outputted.

### BACKGROUND OF THE INVENTION

1. Field of the Invention

The present invention relates to a document processing apparatus and a search method that process plural pieces of document data.

2. Description of the Related Art

Scan data input from an image input device, data in page description language (PDL) received from a client PC, and the like are stored as files in a secondary storage device of an image output device, and users retrieve and output the data repeatedly at any time. Such a function to store the input data in a file format for reuse in a secondary storage device of an image output device is called a “box function”, and the file system is called “box”.

The files in the box are in bit map format or vector data format, and because a high capacity secondary storage device is necessary for storing such data with a high information content, techniques for efficient storage in the box have been developed (for example, see Japanese Patent Laid-Open No. 2006-243943).

Meanwhile, when a large amount of files are stored in the box, it becomes difficult to find a target file from a list of information such as file names and thumbnails.

Given this factor, it is more convenient for the use if only files that match a keyword that is contained in the target file are shown in a list from the files stored in the box.

To enable such a search by a keyword, a technique has been proposed in which additional information (metadata) such as information containing a keyword that the user may want to use for searching is stored along with graphic data (object) in the storage device. Such metadata is information that is not printed out, and is information of character strings, images, and so on contained in the document.

However, when an object is to be searched for after being stored in object/metadata format in the box, in addition to the object, the metadata with correct information must also be stored and provided to the user. When the metadata is stored as is according to the PDL data format, there may be a case where information that had not appeared at the time of printing is left as metadata.

Furthermore, when metadata is composed as is when combining two or more documents, there are cases where information of a search target becomes redundant, and information that has not appeared after the composition remains as metadata. This causes a problem in that the information that has not appeared is picked up by the search and causes confusion on the part of the user, thereby failing to provide metadata with correct information to the user.

### SUMMARY OF THE INVENTION

An object of the present invention is to provide a document processing apparatus and a search method that achieve efficient searches of objects by using metadata.

According to one aspect of the present invention, there is provided a document processing apparatus that processes a plurality of pieces of document data, the apparatus comprising: a holding unit that holds document data including object data and metadata; a detection unit that detects overlapping of objects included in the document data; an addition unit that adds information regarding the overlapping of objects detected by the detection unit to the metadata of the objects included in the document data; a setting unit that allows a user to set search conditions including a condition regarding the overlapping of objects; a search unit that searches for an object that satisfies the search conditions set in the setting unit based on the metadata to which the information regarding the overlapping has been added; and an output unit that outputs a result of the search performed by the search unit.

According to another aspect of the present invention, there is provided a search method carried out by a document processing apparatus that processes a plurality of pieces of document data, the method comprising: detecting overlapping of objects included in the document data; adding information indicating the overlapping of objects detected to metadata of the objects included in the document data held in a holding unit; allowing a user to set search conditions including a condition regarding the overlapping of objects; searching for an object that satisfies the search conditions set based on the metadata to which the information regarding the overlapping has been added; and outputting a result of the search.

Further features of the present invention will become apparent from the following description of exemplary embodiments with reference to the attached drawings.

### BRIEF DESCRIPTION OF THE DRAWINGS

FIG. 1 is a block diagram illustrating the overall configuration of an image processing system according to an embodiment of the present invention.

FIG. 2 is a block diagram illustrating an exemplary configuration of a control unit (controller) of an MFP according to an embodiment of the present invention.

FIG. 3 is a flowchart illustrating a procedure for vectorization processing executed by the image forming apparatus shown in FIG. 2.

FIG. 4 is a diagram illustrating an example of block selection in the vectorization processing in FIG. 3.

FIG. 5 is a diagram illustrating the data structure of a document.

FIG. 6 is a diagram illustrating an example of a case where the document data shown in FIG. 5 is disposed in a memory or a file.

FIG. 7 is a diagram illustrating a specific example of the document data shown in FIG. 5.

FIG. 8 is a flowchart illustrating metadata creation processing performed when new document data is created by composing stored objects, or when a print job of PDL data is stored as document data.

FIG. 9 is a flowchart illustrating specific object search processing using metadata in a device.

FIG. 10 is a flowchart illustrating details of search target condition setting processing defined in step S902 of FIG. 9.

FIG. 11 is a flowchart illustrating search execution processing in step S903 of FIG. 9.

FIG. 12 is a diagram illustrating an example of an operation unit 210, schematically illustrating a touch panel display including an LCD (Liquid Crystal Display) and a transparent electrode attached thereon.

FIG. 13 is a diagram illustrating an example of a user box screen 1300.

FIG. 14 is a diagram illustrating a UI screen displayed when an edit menu key 1313 is pressed on the user box screen 1300.

FIG. 15 is a diagram illustrating a UI screen for setting search conditions.

FIG. 16 is a diagram illustrating a screen showing a list of documents that are determined as matches as a result of a search set in the search condition setting screen 1501 shown in FIG. 15.

FIG. 17 is a diagram illustrating a state in which a star object is below a circle object and the star object is not shown.

FIG. 18 is a diagram illustrating a state in which the star object is below the circle object, but the circle object in the upper layer is semi-transparent.

FIG. 19 is a diagram illustrating a state in which the star object and the circle object are partially overlapped and displayed.

### DETAILED DESCRIPTION OF THE EMBODIMENTS

Preferred embodiment for carrying out the present invention shall be described in detail hereinafter with reference to the drawings.

<System Configuration>

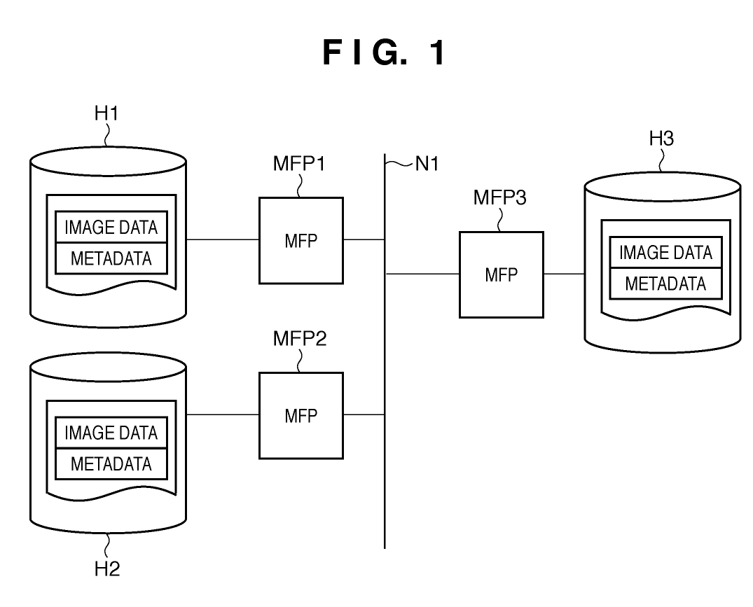

FIG. 1 is a block diagram illustrating the overall configuration of an image processing system according to this embodiment. In FIG. 1, the image processing system is configured of a multifunction peripheral (MFP) 1, an MFP 2, and an MFP 3, connected to each other via a LAN (Local Area Network) N1 or the like. Each of the MFPs has an HDD (Hard Disk Drive: secondary storage device), that is, an H1, an H2, and an H3, respectively. Each HDD holds image data and metadata that are handled in jobs (a scan job, a print job, a copy job, a FAX job, and so on).

The MFP 1, the MFP 2, and the MFP 3 can communicate with each other using network protocols. These MFPs connected via the LAN do not necessarily have to be limited physically to the arrangement as described above. Devices other than the MFPs (for example, PCs, various servers, and printers) may also be connected to the LAN. In the present invention, it is not necessary for a plurality of MFPs to be connected to the network.

<Control Unit Configuration>

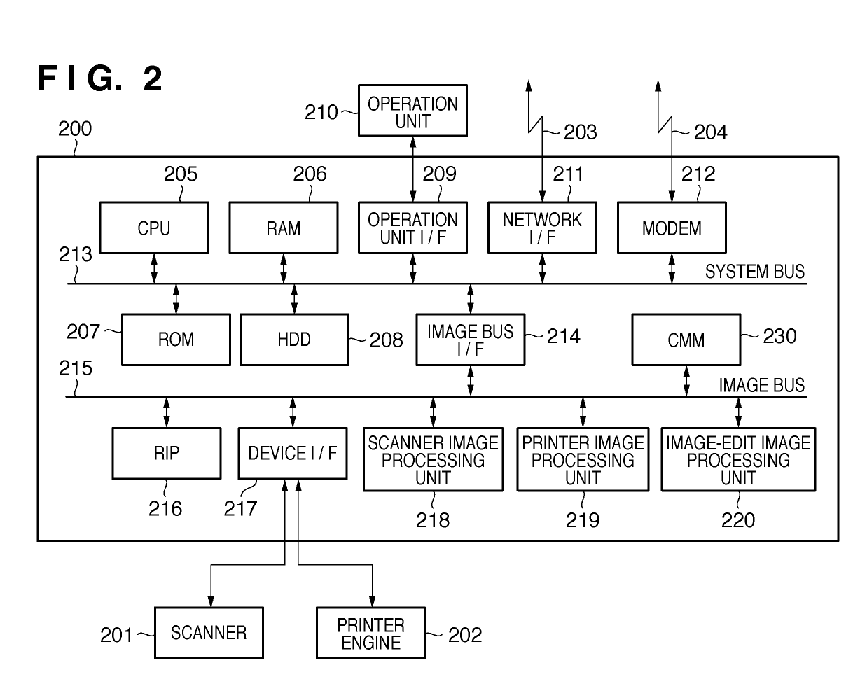

FIG. 2 is a block diagram illustrating an exemplary configuration of a control unit (controller) of an MFP according to this embodiment. In FIG. 2, a control unit 200 is connected to a scanner 201, that is, an image input device, and a printer engine 202, that is, an image output device, and carries out control for reading image data, print output, and the like. The control unit 200 also carries out control for inputting and outputting image information and device information via a network such as a LAN 203, by connecting to the LAN 203, a public line 204, or the like.

A CPU 205 is a central processing unit for controlling the overall MFP. A RAM 206 is a system work memory for the CPU 205 to operate, and is also an image memory for temporarily storing input image data. Furthermore, a ROM 207 is a boot ROM, in which a system boot program is stored. An HDD 208 is a hard disk drive, and stores system software for various processing, input image data, and the like.

An operation unit I/F 209 is an interface unit for an operation unit 210 having a display screen capable of displaying, for example, image data, and outputs operation screen data to the operation unit 210. The operation unit I/F 209 also serves to transmit information inputted by an operator from the operation unit 210 to the CPU 205. The network I/F 211 is realized, for example, using a LAN card, and is connected to the LAN 203 to carry out the input and output of information to and from external devices. A modem 212 is connected to the public line 204, and carries out input and output of information to and from external devices. These units are disposed on a system bus 213.

An image bus I/F 214 is an interface for connecting the system bus 213 with an image bus 215 that transfers image data with at high speed, and is a bus bridge that converts data structures. A raster image processor 216, a device I/F 217, a scanner image processing unit 218, a printer image processing unit 219, an image-edit image processing unit 220, and a color management module 230 are connected to the image bus 215.

The raster image processor (RIP) 216 develops a page description language (PDL) code and vector data to be mentioned later into images. The device I/F 217 connects the scanner 201 and the printer engine 202 with the control unit 200, and carries out synchronous/asynchronous conversion of image data.

The scanner image processing unit 218 carries out various processing such as correcting, processing, and editing image data inputted from the scanner 201. In accordance with the printer engine, the printer image processing unit 219 carries out processing such as correction and resolution conversion on the image data to be output in print. The image-edit image processing unit 220 carries out various image processing such as image data rotation and image data compression and decompression. The CMM 230 is a specialized hardware module that carries out color conversion processing (also called color space conversion processing) on the image data based on a profile, calibration data, or the like.

The profile mentioned here is information such as a function for converting color image data expressed by a device-dependent color space into a device-independent color space (for example, Lab). Meanwhile, the calibration data mentioned here is data for adjusting color reproduction characteristics in the scanner 201 and the printer engine 202.

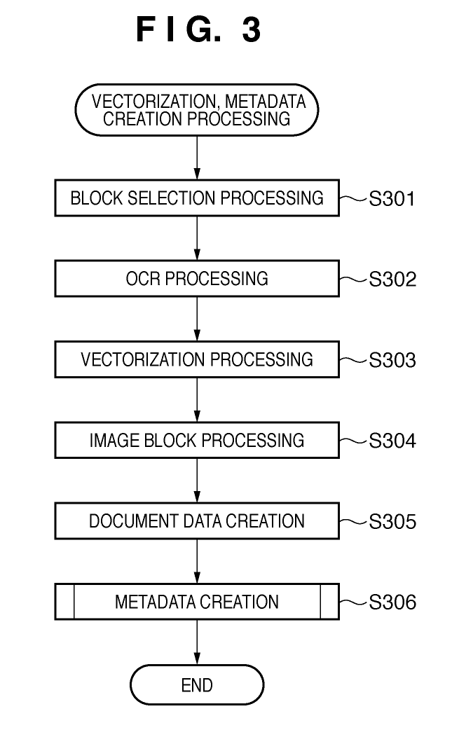

FIG. 3 is a flowchart illustrating a procedure for vectorization processing carried out by the image forming apparatus shown in FIG. 2. This processing is carried out by the CPU 205 of the control unit 200 shown in FIG. 2. In the vectorization processing, bitmap image data (raster data) such as a scanned image is converted into vector data to be mentioned later. The vector data is data that is not dependent on the resolution of the image input device, such as a scanner, that created the bitmap image data.

First, in step S301, block selection processing (region division processing) is carried out for the bitmap image to which the command of vectorization is made. In the block selection processing, the input raster image data is analyzed, each mass of objects included in the image is divided into block-shaped regions, and attributes of each block are determined and classified. The attributes include characters (TEXT), images (PHOTO), lines (LINE), graphic symbols (PICTURE), and tables (TABLE). At this time, layout information of the each block region is also created.

In steps S302 to S305, processing necessary for vectorization is carried out for each of the blocks into which the image was divided in step S301. OCR (optical character recognition) processing is carried out for the blocks determined as the text attribute and for text images included in the table attribute blocks, (step S302). Then, for the text blocks processed by OCR, a size, a style, and a character style of the text are further recognized, and vectorization processing that converts the text in the input image into visually precise font data is carried out (step S303). Although vector data is created by combining the OCR results and font data in the example shown here, the creation method is not limited thereto, and vector data of the text contour may be created by using the contours of the text image (outlining processing). It is particularly desirable to use vector data created from the contours of the text as graphic data, when the amount of similarities in the OCR result is low.

In step S303, vectorization processing is also carried out for line blocks, graphic symbol blocks, and table blocks by outlining. That is, by carrying out contour tracking processing and straight-line approximation processing/curve approximation processing for the line image and ruling lines of the graphic symbols and tables, bitmap image of such regions is converted into vector information. Also, for the table blocks, analysis of the table configuration (number of columns/rows, and cell arrangement) is carried out. Meanwhile, for the image blocks, the image data of each region is compressed as a different JPEG file, and image information relating to the image blocks is created (step S304).

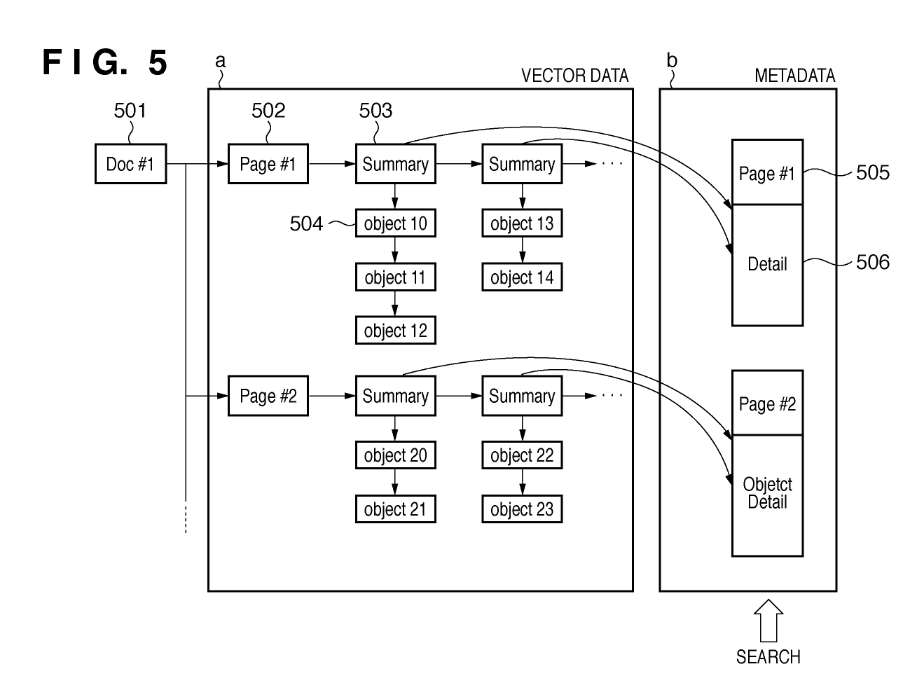

In step S305, attributes of each block and positional information obtained in S301, and OCR information, font information, vector information, and image information extracted in S302 to S304 are stored in document data shown in FIG. 5.

Then, in step S306, metadata creation processing is carried out for the vector data created in step S305. The result of the OCR in step S302, the result of pattern matching of the image region and analysis of the image content, or the like may be used as keywords to be used as this metadata. The metadata created in this manner is added to the document data in FIG. 5.

The above-described steps S301 to S304 are carried out when the input data is a bitmap image. On the other hand, when the input data is PDL data, instead of the steps S301 to S304, the PDL data is interpreted, and data for each object is created. At this time, the object data is created, for the text portion, based on character codes extracted from the PDL data. For the line drawing and graphic symbol portions, the object data is created by converting data extracted from the PDL data into vector data, and for the image portion, the object data is created by converting the data into a JPEG file. Then, these pieces of data are stored in document data in step S305, and metadata is added in step S306.

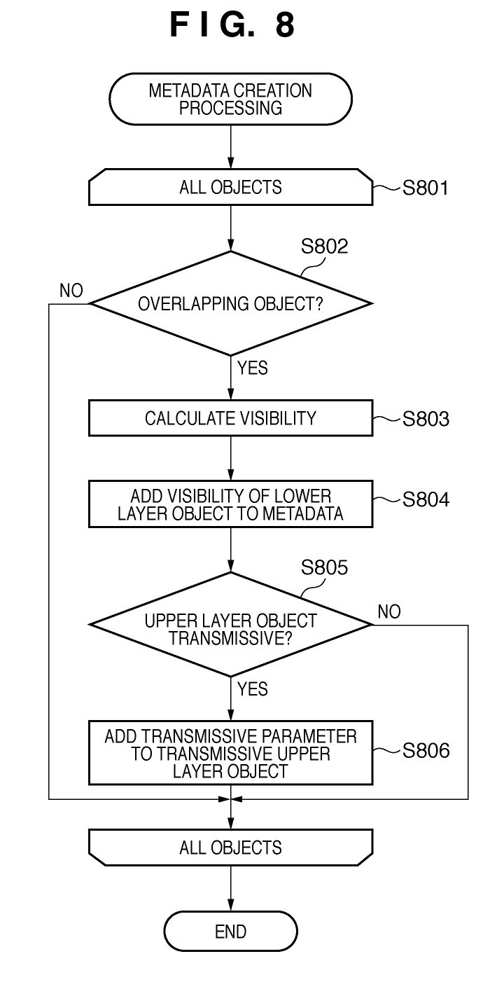

Furthermore, a new document can be created by re-using the objects of the document data stored as described above. At this time, new document data storing the re-used objects is created, and metadata appropriate for the new document is created and added. The metadata creation processing is described in further detail with reference to FIG. 8.

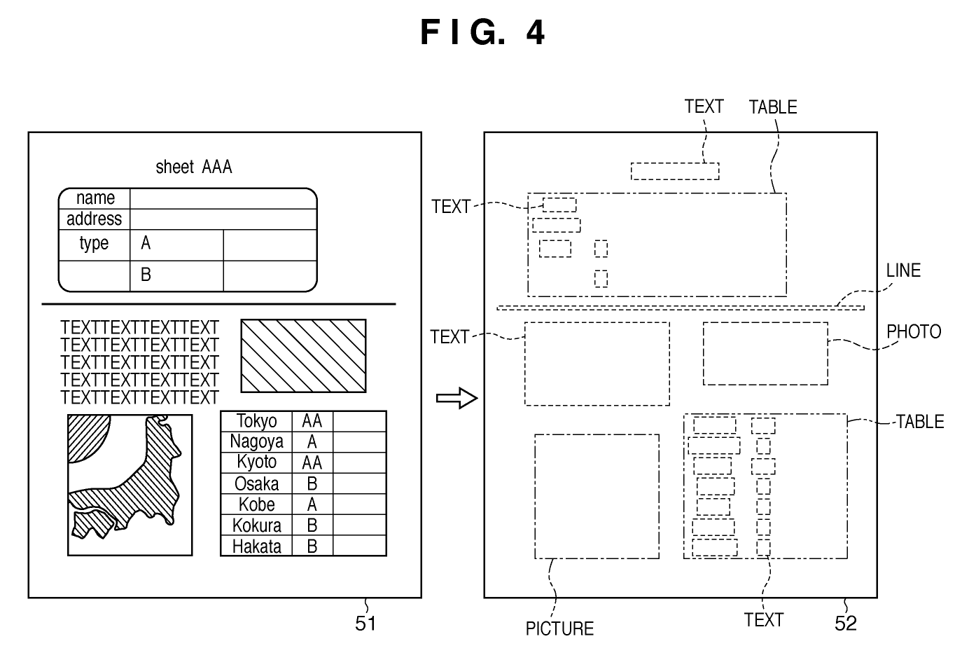

FIG. 4 is a diagram illustrating an example of block selection in the vectorization processing in FIG. 3. In FIG. 4, a determination result 52 shows a result of carrying out the block selection to an input image 51. In the determination result 52, the portions encircled by the dotted lines represent respective units of the objects as a result of analyzing the image, and the types of the attributes given to each object are the determination results of the block selection.

The vector data (text data (character recognition result information, font information), vector information, table configuration information, image information), and metadata created in the metadata creation processing relating to each object are stored in the document data.

<Document Data Structure>

The structure of the document data is described next with reference to FIG. 5 to FIG. 7. FIG. 5 is a diagram illustrating the data structure of a document. The document data includes a plurality of pages; is configured of, roughly divided, vector data “a” and metadata “b”; and has a hierarchical structure with a document header 501 at the top. The vector data “a” is configured of a page header 502, summary information 503, and an object 504, and the metadata “b” is configured of page information 505 and detailed information 506.

Although not shown here, a display list suitable for printing out by the device may further be created and managed in relation to the aforementioned document data for each page in the document. In this case, the display list is configured of a page header for identifying each page and instructions for graphic expansion. By managing a display list together in such a fashion, printing can be executed quickly when the document is to be printed by the device without editing.

The vector data “a” stores the OCR information, the font information, the vector information, and graphic data, such as image information. In the page header 502, layout information such as the size and orientation of the page is written. Graphic data such as a line, a polygon, and a Bézier curve are linked, one each, to the object 504. Then, a plurality of objects are collectively associated with the summary information 503 by region units into which the image was divided in the block selection processing. The summary information 503 represents characteristics of a plurality of objects altogether, and the attribute information of the divided region described in FIG. 4, for example, is written therein. The summary information 503 is also associated (linked) with metadata for searching respective regions.

The metadata “b” is additional information for searches and is unrelated to graphic processing. Page information telling, for example, whether the metadata is created from bitmap data or from PDL data, is written in the page information 505. In the detailed information 506, for example, OCR information and character strings (character code strings) created as image information to be used for a search are written. In this way, a character string to be used for searching each object included in the document data can be stored in the metadata. The character string for searching can include a character code extracted from PDL, a character code of a result of the OCR on the image, and a character code input through keys by a user.

Furthermore, the summary information 503 in the vector data “a” refers to the metadata, the detailed information 506 can be found from the summary information 503, and the corresponding summary information 503 can also be found from the detailed information 506.

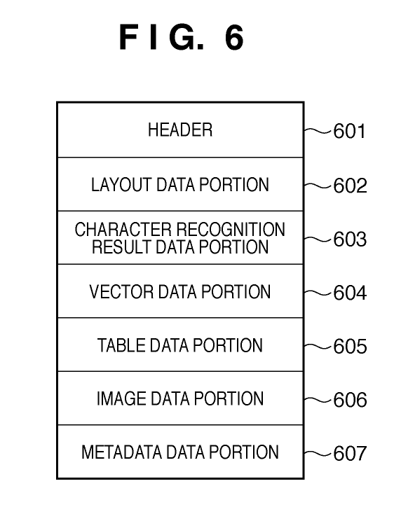

FIG. 6 is a diagram illustrating an example of a case where the document data shown in FIG. 5 is disposed in a memory or a file. A header 601 holds information relating to image data to be processed. A layout data portion 602 holds attribute information and rectangular address (coordinates) information of each block recognized as having attributes such as characters, images, lines, graphic symbols, and tables in the input image data.

A character recognition result data portion 603 holds a result of character recognition obtained by the character recognition of the character blocks. A vector data portion 604 holds vector data such as line drawings and graphic symbols. A table data portion 605 stores details of the configuration of the table blocks. An image data portion 606 holds image data cut out from the input image data. A metadata data portion 607 stores metadata created from the input image data.

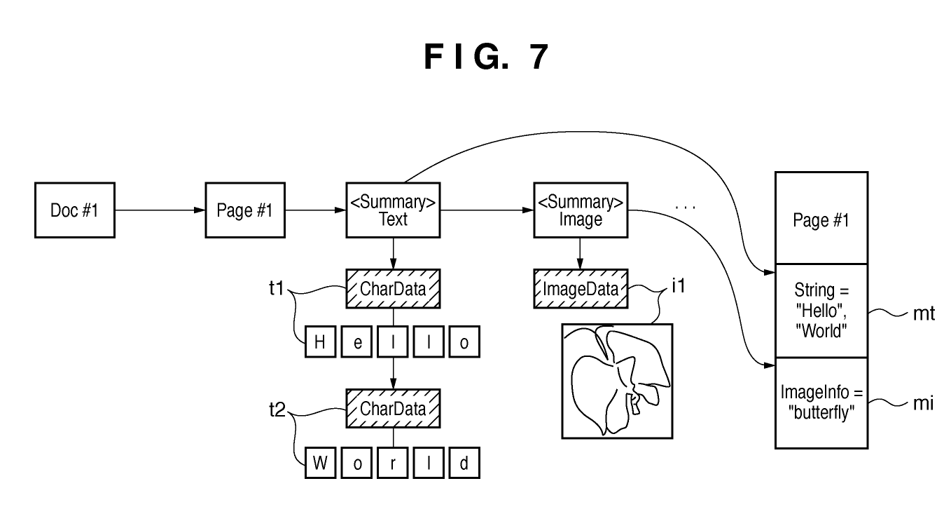

FIG. 7 is a diagram illustrating a specific example of the document data shown in FIG. 5. It is assumed that a text region and an image region are included in the first page of the input image data (for example, PDL data and scan data). At this time, “TEXT” and “IMAGE” are created as summary information of the first page. Text contours of an object t1 (Hello) and an object t2 (World) are linked to the summary information of “TEXT” as vector data. Furthermore, summary information (TEXT) is linked to a character code string (metadata “mt”) for “Hello” and “World”.

A photographic image (JPEG) of a butterfly is linked to the summary information of “IMAGE” as an image object i1. Furthermore, the summary information (IMAGE) is linked to image information (metadata mi) of “butterfly”.

Therefore, when using a keyword, for example, “World”, to search text in the page, the detection can be carried out as in the following procedure. First, vector page data is sequentially obtained from the document header, and then metadata mt linked to “TEXT” is retrieved from the summary information linked to the page header. Then, in the case shown in FIG. 7, the first page of document 1 containing “World” in metadata linked to “TEXT” is searched, and the page is output as a search result.

FIG. 8 is a flowchart illustrating metadata creation processing performed when new document data is created by composing stored objects, or when a print job of PDL data is stored as document data. The visibility and the transmissive parameter described in FIG. 8 are stored as metadata along with OCR data and image analysis result data of each object described in S304 of FIG. 3.

Step S801 is a loop for repeatedly carrying out the processing from steps S802 to S806 on all the objects stored in the document data. In step S802, a determination is made as to whether or not another object is overlapped on a processing target object. When it is determined that an upper layer object is present and overlapping, the processing moves to S803. When it is determined that an upper layer object is not present and not overlapping, a next object is set as a target object, and the processing continues.

In step S803, a visibility (ratio at which the lower layer object is to be displayed without being overlapped by the upper layer object) of the overlapped lower layer object is calculated. As for the calculation method for this visibility, a ratio of the area of the object that is actually displayed relative to the object area may be employed. Also, to further simplify the calculation, the visibility can be calculated based on the ratio of an area of a non-overlapped portion of a circumscribed rectangular region of the lower layer object relative to the whole area of a circumscribed rectangular region of the lower layer object.

Then, in step S804, the visibility calculated in step S803 is added as metadata of the lower layer object.

In step S805, it is determined whether or not the object in the upper layer to the target object is a transmissive object (transparent or semi-transparent object). When it is determined that the object is a transmissive object, the processing moves to S806. When it is determined that the upper layer object is not a transmissive object, the next object is set as a target object, and the processing continues.

In step S806, the transmissive parameter is added to metadata of the upper layer object. Then, after completing the aforementioned processing for all the objects, this processing is terminated.

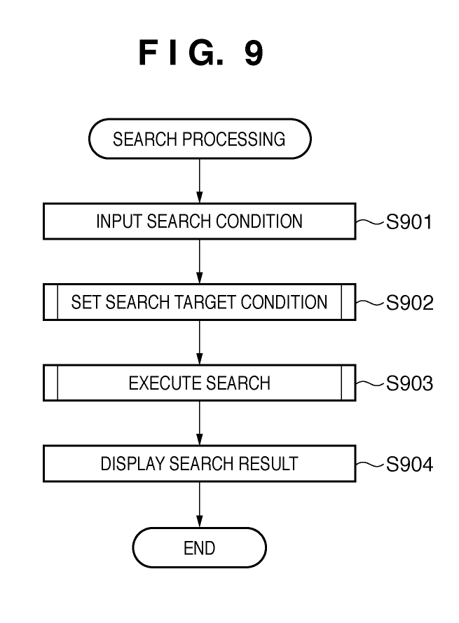

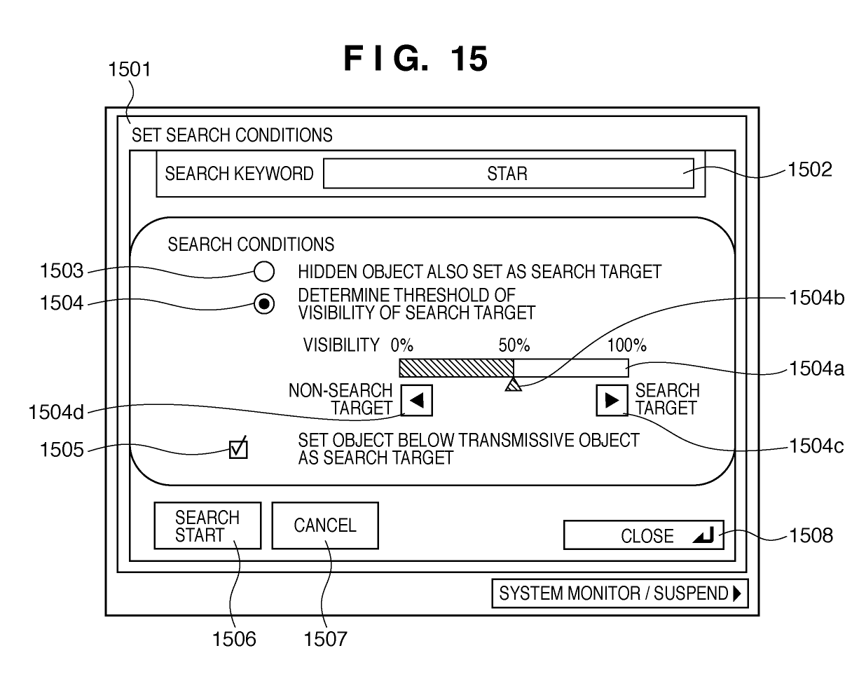

FIG. 9 is a flowchart illustrating specific object search processing using metadata in a device. First, in step S901, an MFP displays the search condition setting screen (user interface for setting search conditions) shown in FIG. 15, for a user to enter conditions for a search target object. In step S902, conditions for the search target are set based on conditions input in step S901.

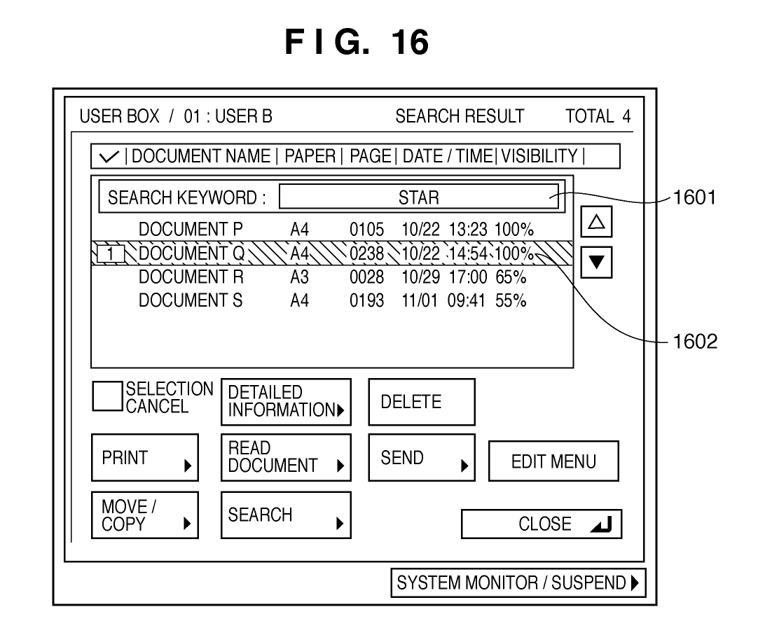

Next, in step S903, a search is executed based on the search conditions set in step S902. Then, in step S904, a search result including objects that are satisfying the search conditions set in step S902 is displayed. FIG. 16 is a diagram illustrating an example of a display screen of a search result including objects that satisfied the search conditions. Although a document including objects that satisfied the search conditions is shown in FIG. 16, it is not limited thereto, and a page including such objects in the document may also be shown.

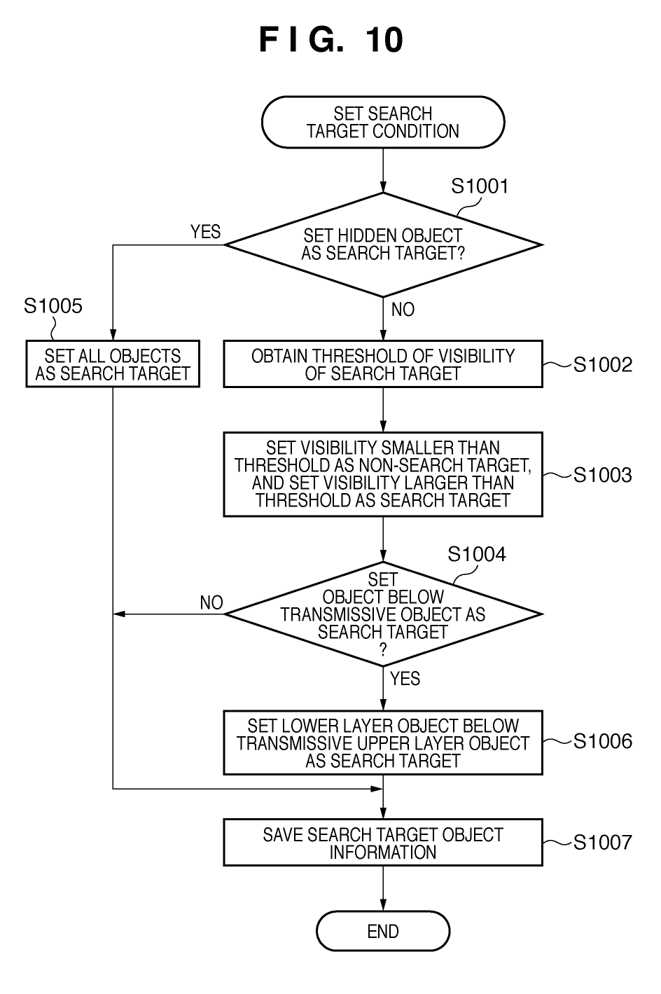

FIG. 10 is a flowchart illustrating details of search target condition setting processing defined in step S902 of FIG. 9. First, in step S1001, it is determined whether or not an option 1503, that is, “search target includes hidden objects” is selected by the user's command in a search condition setting screen 1501 of FIG. 15. When the option 1503 is selected, the processing moves to S1005. On the other hand, when the option 1503 is not selected, and an option 1504, i.e., “decides threshold of visibility of search target”, is selected, the processing moves to S1002.

In step S1005, all objects are set as search targets. Meanwhile, in step S1002, a threshold of the visibility is obtained for the search target set by the user through the search condition setting screen 1501 of the operation unit 210.

Next, in step S1003, those objects having a visibility lower than the threshold of the visibility obtained in step S1002 are set to a non-search target, and those objects having a visibility higher than the threshold of the visibility obtained in step S1002 are set to a search target.

In step S1004, it is determined whether or not the object below the transmissive object is set as a search target. That is, when it is determined that a check box 1505, that is, “object in layer lower than transmissive object set as search target”, is selected in the search condition setting screen 1501 in FIG. 15, the processing moves to S1006. On the other hand, when it is determined that the check box 1505 is not selected, the processing moves to S1007.

In step S1006, among the objects set as non-search targets in step S1004, those lower layer objects below a transmissive upper layer object are set as search targets. The determination as to whether or not the upper layer object is a transmissive object can be made based on whether or not the transmissive parameter has been given to the metadata of the upper layer object.

Then, in step S1007, the search target conditions decided in the aforementioned steps S1002 to S1006 are saved.

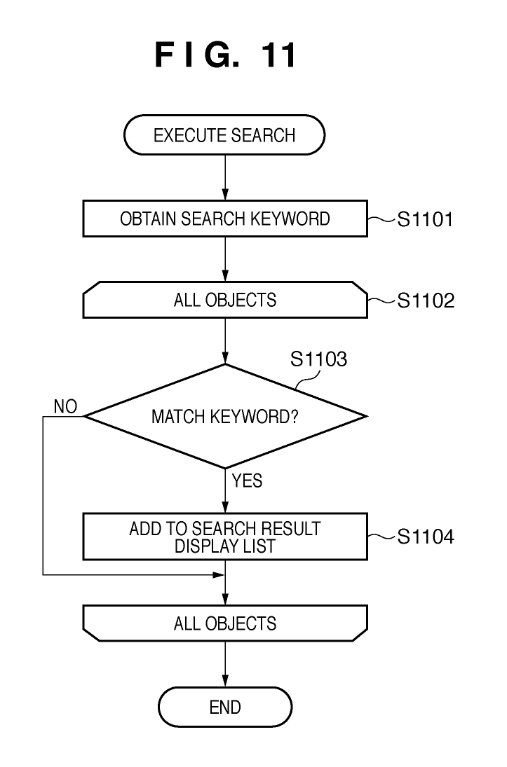

FIG. 11 is a flowchart illustrating search execution processing in step S903 of FIG. 9. First, in step S1101, a search keyword 1502 inputted through the search condition setting screen 1501 of FIG. 15 by a user is obtained.

Step S1102 is a loop for repeatedly executing following processing steps S1103 to S1105 on objects stored as search targets in step S1007 in order.

In step S1103, it is determined whether or not the objects to be processed match the search keyword. When an object matches the keyword, the processing moves to S1104. On the other hand, when an object does not match the keyword, the processing goes back to step S1102 and set the next object as the search target.

In step S1104, the objects to be processed that are determined as matches to the keyword are added to a search result display list. That is, those objects that are determined as satisfying the search target conditions 1503 to 1504 set in FIG. 15 are set as keyword search targets in order, and among these, those objects that match the search keyword 1502 are listed.

Then, when the aforementioned processing is completed for all the objects stored as the search target objects in step S1007 of FIG. 10, the processing is terminated.

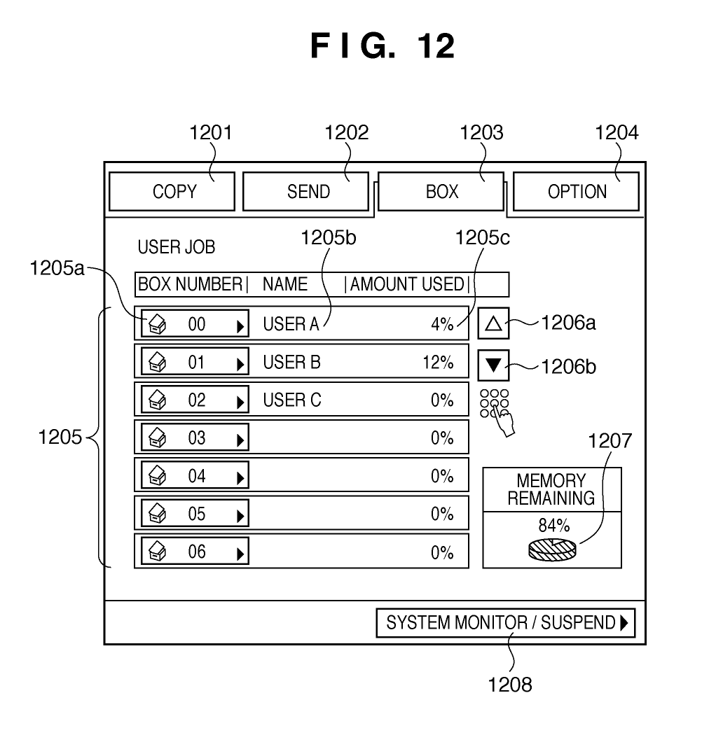

FIG. 12 is a diagram illustrating an example of the operation unit 210, schematically illustrating a touch panel display including an LCD (Liquid Crystal Display) and a transparent electrode attached thereon. The operation unit 210 is programmed in advance so that when a transparent electrode of a portion corresponding to a key shown on the LCD is touched with a finger, for example, the touch is detected and another operation screen is shown.

As shown in FIG. 12, a copy tab 1201 is a tab key for shifting to an operation screen for a copy operation. A send tab 1202 is a tab key for shifting to an operation screen for instructing a send operation, by which a facsimile, an E-mail, or the like is sent. A box tab 1203 is a tab key for shifting to a screen for an output/input operation of a job in a box (memory unit for storing jobs for each user). An option tab 1204 is a tab key for setting optional functions such as scanner setting.

A system monitor key 1208 is a key for displaying the status and condition of the MFP. By selecting one of the tabs, it is possible to shift to an operation mode. The example shown in FIG. 12 illustrates the box selection screen displayed after the box tab has been selected and the screen has shifted to the box operation screen.

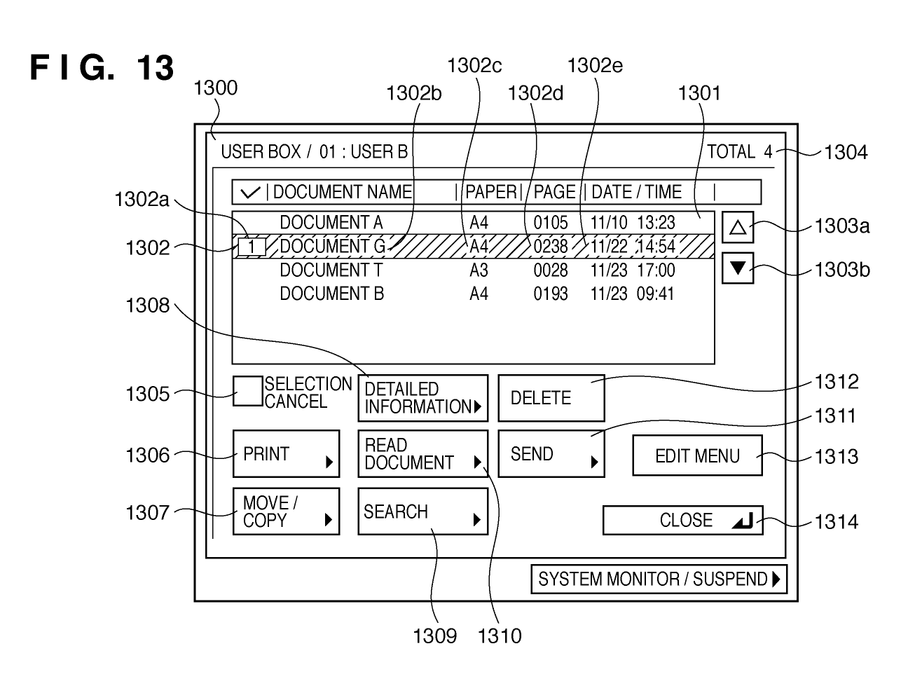

FIG. 12 is a schematic diagram illustrating an example of a screen of an LCD touch panel when the box tab 1203 is pressed. In FIG. 12, 1205 shows information of each box, such as a box number 1205a, a box name 1205b, and an amount used 1205c. The amount used 1205c shows information as to how much of the capacity of the box region in the hard disk 208 the box occupies. When the box number 1205a with a box name of “user B” is pressed, a shift is made to a user box screen, mentioned later (FIG. 13).

1206a and 1206b are up and down scroll keys, which are used to scroll the screen when the number of the boxes that can be displayed on the screen at once is registered.

FIG. 13 is a diagram illustrating an example of the user box screen 1300. 1301 is a list of documents stored in the box. In this example, document A, G, T, and B are stored. The rectangle of 1302 indicates the document currently selected in the box.

1302a is a mark indicating the order of the documents selected. 1302b is the name of the document selected. 1302c is the paper size of the document selected. 1302d is the page number of the document selected. 1302e indicates date and time when the document selected was stored.

1303a and 1303b are up and down scroll keys, which are used for scrolling the screen when the number of the documents stored exceeds the number of documents that can be displayed in 1301.

1305 is a selection cancel key, which cancels the selection of the document selected in 1302. 1306 is a print key, for shifting to a print setting screen when printing the document selected in 1302. 1307 is a move/copy key, for shifting to a move/copy setting screen which moves/copies the selected document to other boxes.

1308 is a detailed information key, for shifting to a detail display screen of the document selected in 1302. 1309 is a search key, for shifting to the search condition setting screen shown in FIG. 15. 1310 is a document read key, for shifting to a document read setting screen. 1311 is a send key, for shifting to a send setting screen for sending the document selected.

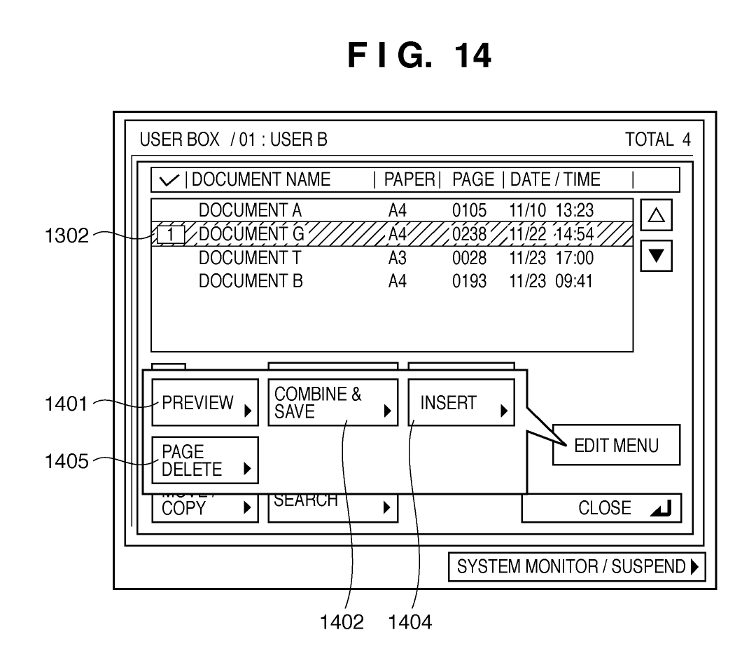

1312 is a delete key, for deleting the document selected in 1302. 1313 is an edit menu key, for shifting to an edit screen (FIG. 14) for the document selected in 1302. 1314 is a close key, for closing the screen and returning to the operation screen (FIG. 12).

FIG. 14 is a diagram illustrating a UI screen displayed when the edit menu key 1313 is pressed on the user box screen 1300. 1401 is a preview key, for shifting to a preview setting screen of the document selected in 1302. 1402 is a combine & save key, for shifting to a combine & save setting screen of the document selected in 1302.

1404 is an insert key, for shifting to an insert setting screen for additionally inserting a page to the document selected in 1302. 1405 is a page delete key, for deleting a page in the document selected in 1302.

FIG. 15 is a diagram illustrating a UI screen for setting search conditions. 1501 is a UI screen. 1502 is a search keyword input field, for inputting a keyword for an object a user wants to search in a network the user in connected to or in an accessible box.

1503 is a radio button for selecting the option of “hidden object also set as search target”. The “hidden object also set as search target” means that those objects that are hit by the search keyword are set as search targets even when these objects are positioned below other objects. Such objects hidden under other objects do not appear in front when printed, and therefore the presence of such objects cannot be checked.

However, depending upon usage, a user may possibly edit such hidden objects after the search, and therefore they also can be set as a search target.

1504 is a radio button for selecting the option of “determine threshold of visibility of search target”. The “determine threshold of visibility of search target” allows a user to set a threshold for determining whether or not the object hit by the search are set as search targets according to the ratio at which they are displayed.

1504a is a bar indicating a visibility as well as a search target and a non-search target. Arrow keys 1504c and 1504d are pressed to move an arrow 1504b indicating the threshold of the search target to left and right, thereby determining the threshold of the visibility of the non-search target and the search target.

The portion shown in gray (the left side) of the visibility bar 1504a indicates the visibility for the non-search target, and the portion shown in white (the right side) indicates the visibility of the search target. In the example of FIG. 15, the threshold for the search target is set as 50%, and therefore those objects having the visibility of 50% or more are set as the search targets, and those objects having the visibility of below 50% are set as the non-search target.

1505 is a check box for selecting “object below transmissive object set as search target”. By selecting this “object below transmissive object set as search target”, the object below the transmissive object can be set as a search target.

1506 is a search start key, and when pressed, a search is started with the conditions set in the aforementioned procedure. 1507 is a cancel key, and when pressed, those items set in the search condition setting screen 1501 are canceled. 1508 is a close key, and when pressed, the search condition setting screen 1501 is closed, and the screen returns to the screen 1300 shown in FIG. 13.

FIG. 16 is a diagram illustrating a screen showing a list of documents that are determined as matches as a result of a search set in the search condition setting screen 1501 in FIG. 15. 1601 displays a keyword used for the search. 1602 indicates the visibility of the object in the document in the search result.

FIG. 16 shows a search result when the threshold is set to 50% or more as the conditions shown in FIG. 15, and the visibilities of the objects searched are 50% or more for all objects.

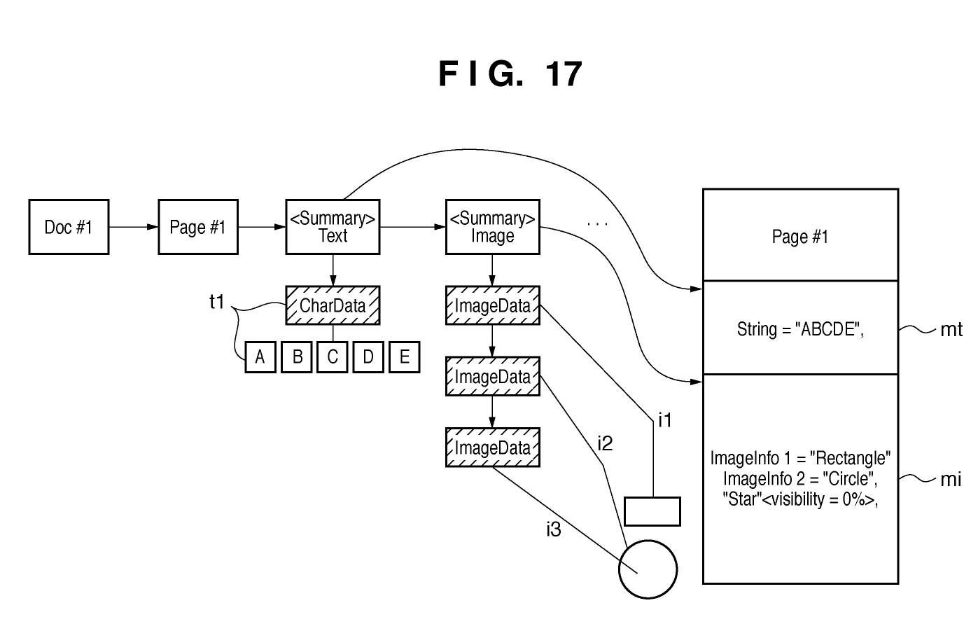

FIG. 17 to FIG. 19 are diagrams illustrating three types of display states, as well as vector data and metadata, according to this embodiment. It is assumed that the document data includes a text object (t1); image objects (i1, i2, i3); metadata of the text object (mt); and metadata of the image object (mi). The circle image object i2 and the star image object i3 are overlapped, as described below.

FIG. 17 is a diagram illustrating a state in which a star object is below a circle object and the star object is not shown. For the metadata for the star object, overlap visibility attributes are given, and the visibility of 0% is added.

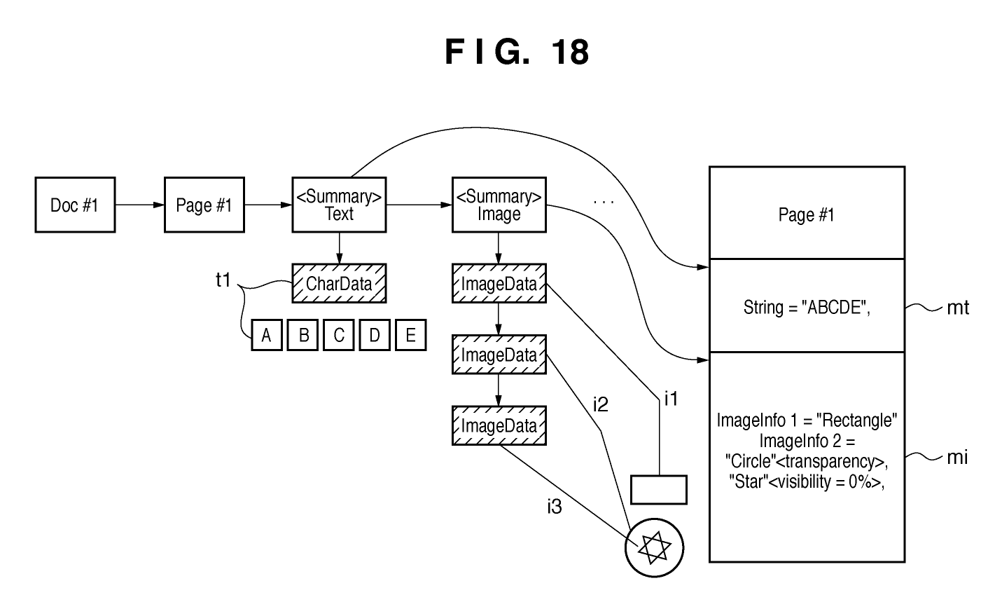

FIG. 18 is a diagram illustrating a state in which the star object is below the circle object, but the circle object in the upper layer is semi-transparent. Transmissive attributes are given to the metadata of the circle object. Overlap visibility attributes relative to the upper layer object are given and the visibility of 0% is added to the metadata of the star object in the lower layer.

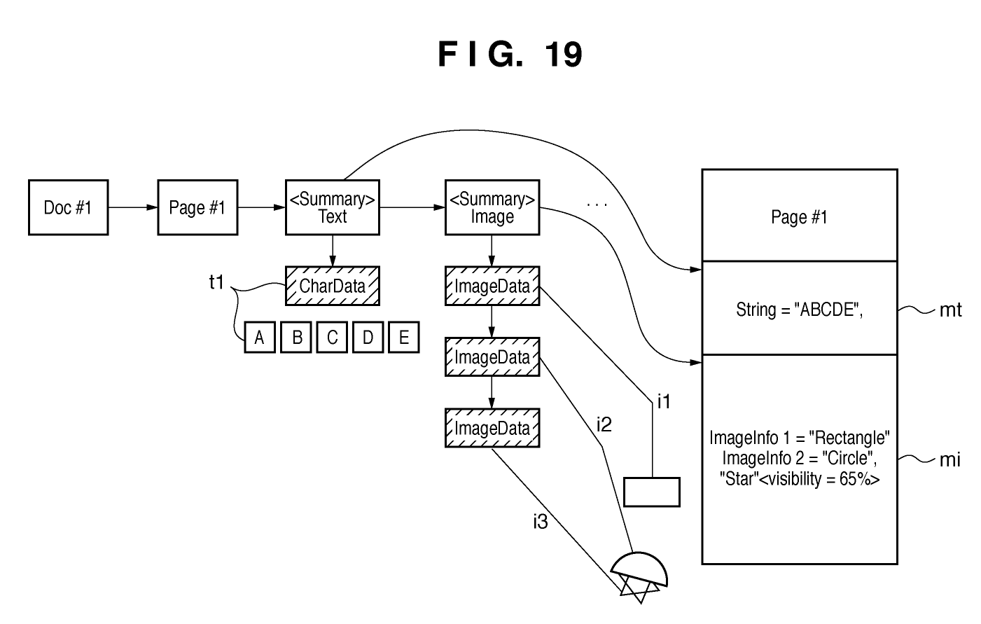

FIG. 19 is a diagram illustrating a state in which the star object and the circle object are partially overlapped and displayed. Overlap visibility attributes are given and the visibility of 65% is added to the metadata of the star object.

According to this embodiment, when creating metadata for a print job, or creating metadata for overlapping composition, information relating to object overlapping (for example, a visibility, transmissive parameters, or the like) can be added to the metadata. Then, by allowing a user to specify information relating to overlapping at the time of search, only metadata of significant objects can be set as a search target.

Therefore, data not displayed and objects unnecessary for the user are prevented from being hit in the search, allowing efficient search of necessary objects. Also, by allowing the setting of the search conditions, a search appropriate for purposes of the user can be carried out.

The present invention may be applied to a system configured of a plurality of devices (for example, a host computer, an interface device, a reader, and a printer), or may be applied to an apparatus configured of a device (for example, a copier and a facsimile machine).

Furthermore, it goes without saying that the object of the present invention can also be achieved by supplying, to a system or apparatus, a recording medium in which the program code for software that realizes the functions of the aforementioned embodiments has been stored, and causing a computer (CPU or MPU) of the system or apparatus to read out and execute the program code stored in the storage medium.

In such a case, the program code itself read out from the computer-readable recording medium implements the functionality of the aforementioned embodiments, and the storage medium in which the program code is stored composes the present embodiment.

Examples of a storage medium for supplying the program code include a flexible disk, a hard disk, an optical disk, a magneto-optical disk, a CD-ROM, a CD-R, magnetic tape, a non-volatile memory card, a ROM, and so on.

Moreover, it goes without saying that the following case also falls under the scope of the present invention, which is not limited to implementing the functions of the aforementioned embodiment by a computer executing the read-out program code. That is, the case where an operating system (OS) or the like running in a computer performs part or all of the actual processing based on instructions in the program code, and the functionality of the aforementioned embodiment is realized by that processing, is included in the scope of the present invention.

Furthermore, the program code read out from the recording medium may be written into a memory provided in a function expansion board installed in the computer or a function expansion unit connected to the computer. Then, a CPU or the like included in the expansion board or expansion unit performs all or part of the actual processing based on instructions included in the program code, and the functions of the aforementioned embodiment may be implemented through that processing. It goes without saying that this also falls within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-318994, filed Dec. 10, 2007, which is hereby incorporated by reference herein in its entirety.

What is claimed is:

1. A document processing apparatus that processes a plurality of pieces of document data, the apparatus comprising:
a holding unit that holds document data including object data and metadata;
a detection unit that detects overlapping of objects included in the document data;
an addition unit that adds information regarding the overlapping of objects detected by the detection unit to the metadata of the objects included in the document data;
a setting unit that allows a user to set search conditions including a condition regarding the overlapping of objects;
a search unit that searches for an object that satisfies the search conditions set in the setting unit based on the metadata to which the information regarding the overlapping has been added; and
an output unit that outputs a result of the search performed by the search unit.

2. The apparatus according to claim 1, wherein when an upper layer object and a lower layer object are overlapping, the addition unit calculates a visibility of the lower layer object, and adds the calculated visibility to the metadata.

3. The apparatus according to claim 2, wherein when the upper layer object is a transmissive object, the addition unit adds a transmissive parameter to the metadata.

4. The apparatus according to claim 2, wherein the search conditions set in the setting unit include a threshold of the visibility of the lower layer object.

5. The apparatus according to claim 4, wherein the search unit sets an object having a visibility higher than the threshold set in the setting unit as a search target.

6. The apparatus according to claim 3, wherein the search conditions set in the setting unit include whether or not an object below the transmissive object is set as a search target.

7. The apparatus according to claim 1, wherein the search conditions set in the setting unit include whether or not a hidden object is set as a search target.

8. The apparatus according to claim 1, wherein the setting unit displays a user interface for setting whether or not a hidden object is set as a search target, a threshold regarding the visibility of an object set as a search target, and whether or not an object below a transmissive object is set as a search target, thereby allowing a user to set the search conditions including a condition regarding the overlapping of objects via the displayed user interface.

9. The apparatus according to claim 1, wherein search conditions set in the setting unit include a condition regarding the overlapping of objects and a search keyword, and
the search unit searches for an object that satisfies the condition regarding the overlapping of objects and the search keyword set in the setting unit based on the metadata.

10. The apparatus according to claim 1, wherein the object data is vector data of the object or image data of the object.

11. The apparatus according to claim 1, wherein the output unit outputs a document including the object searched for, or a page including the object searched for.

12. A search method carried out by a document processing apparatus that processes a plurality of pieces of document data, the method comprising:
detecting overlapping of objects included in the document data;
adding information indicating the overlapping of objects detected to metadata of the objects included in the document data held in a holding unit;
allowing a user to set search conditions including a condition regarding the overlapping of objects;
searching for an object that satisfies the search conditions set based on the metadata to which the information regarding the overlapping has been added; and
outputting a result of the search.

13. A computer-readable recording medium on which is stored a program for causing a computer to execute the search method according to claim 12.
